(19) United States
(12) Patent Application Publication
(10) Pub. No.: US 2007/0299603 A1
(43) Pub. Date: Dec. 27, 2007

(54) Apparatus and Method of Extending Information in Position History Data Set for Vehicle

(75) Inventors: ANDREW C. KIRBY, DEER PARK, IL (US); SHAFER B. SEYMOUR, BARTLETT, IL (US)

Correspondence Address: MOTOROLA, INC., 1303 EAST ALGONQUIN ROAD, IL01/3RD, SCHAUMBURG, IL, 60196, US

(73) Assignee: MOTOROLA, INC., SCHAUMBURG, IL (US)

(21) Appl. No.: 11/426,826

(22) Filed: Jun. 27, 2006

(51) Int. Cl. G01C 21/00

(52) U.S. Cl. 701/207; 701/200

(57) ABSTRACT

Position points of a vehicle are stored in a database as a vehicle travels. New position points are obtained and assigned confidence levels based on how they are obtained. A new position point can replace the oldest, unprotected position point if the confidence level of the new position point is not greater than at least one of the protected position points. A new position point can replace one of the protected position points if the confidence level of the new position point is greater than the protected position point. A new position point can replace the oldest, protected position point if the confidence level of the new position point is equal to or greater than the oldest, protected position point. The position points in the database can be transmitted to a remote service provider.

### FIELD OF THE DISCLOSURE

The subject matter of the present disclosure relates to an apparatus and method of extending information in a position history data set for a vehicle.

### BACKGROUND OF THE DISCLOSURE

Devices for vehicles are known in the art that record a position history of the vehicle as it travels. For example, a Telematics device used with Telematics services is one type of device that can record position history of a vehicle as it travels. One way to obtain the position of the vehicle is to use a Global Positioning System (GPS). As is known in the art, GPS is used to derive a position of a vehicle on the earth using a constellation of GPS satellites as reference points. Another way to obtain the position of the vehicle is to use dead reckoning. As is known in the art, dead reckoning is used to derive a change in a vehicle's position as it travels without using an external reference. For example, the slight differences in the rotation between the vehicle's wheels can be used to calculate a current position and the distance that the vehicle has traveled over a period of time.

In some situation, the device in the vehicle may obtain a position history that is degraded or contains errors when compared to what the device can obtain in other situations. For example, the device in a vehicle traveling through a tunnel may have to rely solely on dead reckoning, which provides a less accurate position fix than GPS. As the vehicle travels through the tunnel, the device continually updates its position and records the updated positions in a history. The position history is a list containing a finite number of vehicle positions or “breadcrumbs.”

Over time, substantial errors may accumulate in the position history. Due to the errors, it may not be possible to determine the actual position of the device when the position history is plotted on a map. For example, it is common in Europe for long tunnels to extend under other complex road systems. The substantial errors in the position history of the vehicle traveling in such a tunnel may erroneously indicate that the vehicle is located on another road system rather than located in the tunnel.

The subject matter of the present disclosure is directed to overcoming, or at least reducing the effects of, one or more of the problems set forth above.

### BRIEF DESCRIPTION OF THE DRAWINGS

Embodiments and other aspects of subject matter of the present disclosure will be best understood with reference to a detailed description of specific embodiments, which follows, when read in conjunction with the accompanying drawings, in which:

FIG. 1 schematically illustrates an embodiment of a position history apparatus for a vehicle;

FIG. 2 diagrammatically illustrates a plurality of actual position points of a vehicle traveling along a path;

FIG. 3A diagrammatically illustrates a plurality of position points determined by the position history apparatus using dead-reckoning techniques;

FIG. 3B illustrates a data set in chart form having a history of position points from FIG. 3A;

FIG. 4A diagrammatically illustrates position points determined by the position history apparatus using corrective techniques according to the present disclosure;

FIG. 4B illustrates a data set in chart form having a history of the corrected position points from FIG. 4A; and

FIG. 5 illustrates an embodiment of a process for maintaining preferred position points in memory.

While the subject matter of the present disclosure is susceptible to various modifications and alternative forms, specific embodiments thereof have been shown by way of example in the drawings and are herein described in detail. The figures and written description are not intended to limit the scope of the inventive concepts in any manner. Rather, the figures and written description are provided to illustrate the inventive concepts to a person skilled in the art by reference to particular embodiments, as required by 35 U.S.C. § 112.

### DETAILED DESCRIPTION

A vehicle position history apparatus and method are disclosed. In one embodiment, the vehicle position history apparatus has at least one device configured to obtain vehicle positions of a vehicle. The at least one device can include one or more of a GPS device, a wireless communication device, and a dead-reckoning device. The apparatus also has a database configured to store a history of position points of the vehicle. The position points have confidence levels. The apparatus can also include a wireless communication device operatively coupled to the controller and configured to transmit the position points stored in the database.

A controller is operatively coupled to the at least one device and the database. When a new position point of the vehicle is obtained, the controller assigns a confidence level to the new position point based on how the new position point of the vehicle is obtained. For example, the new position point is assigned with a high confidence level if it has been obtained using a GPS. In another example, the new position point is assigned with a low confidence level if it has been obtained using dead reckoning only.

Once the confidence level is assigned, the new position point is stored in the database. The database, however, may have a limited number of entries for storing position points for the vehicle. If the database has a free entry, then the controller stores the new position point in the available entry. If the database does not have a free entry, then the controller determines which position point in the database to replace with the new position point. For example, the controller can determine which unprotected position point in the database is the oldest entry. In addition, the controller can determine whether the new position point has a higher confidence level than any of the existing position points in the database.

Based on the determination, the controller replaces the determined position point with the new position point. The controller may then compare the confidence levels of the position points in the database and determine which of those position points to protect. Consequently, one or more entries of the position data stored in the database that have confidence levels greater than the confidence levels of the other entries of the position data stored in the database can be at least temporarily protected from being replaced by new position points.

The foregoing description is not intended to summarize each potential embodiment or every aspect of the present disclosure. Let us now turn to the drawings to discuss the position history apparatus and method of the present disclosure in more detail.

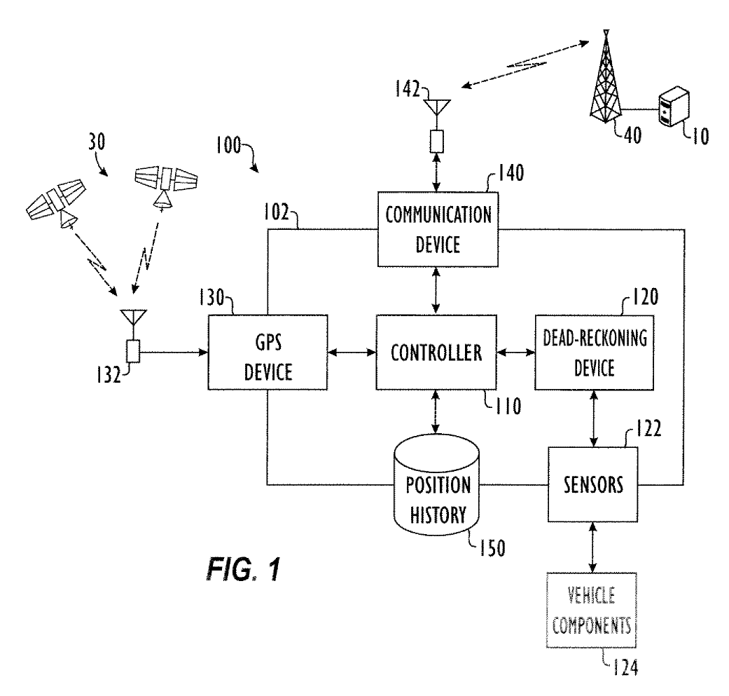

FIG. 1 illustrates an embodiment of a position history apparatus 100 for a vehicle 102. The position history apparatus 100 includes a controller 110, a dead-reckoning device 120, a GPS device 130, a communication device 140, and a position history database 150. The controller 110 can include any suitable programmable device known and used in vehicles. The controller 110 acts as the central processor to the position history apparatus 100. Accordingly, the controller 110 is operatively coupled to the dead-reckoning device 120, the GPS device 130, the communication device 140, and the position history database 150.

The dead-reckoning device 120 is connected to one or more sensors 122 that are in turn connected to one or more vehicle components 124. The dead-reckoning device 120 and sensors 122 can include any suitable devices and components known and used in vehicles for dead reckoning. During operation, the sensors 122 monitor the vehicle components 124 and relay sensed information to the dead-reckoning device 120. In turn, the dead-reckoning device 120 processes the sensed information to determine a plurality of vehicle positions (i.e., position points of the vehicle 102) over time as the vehicle 102 travels.

For example, one of the sensors 122 can be the vehicle's odometer for monitoring the distance traveled and the speed of the vehicle 120. In another example, one of the sensors 122 can be a compass, dual-gimbaled gyroscope, or the like for monitoring direction or orientation of the vehicle 102. In one implementation, the dead-reckoning device 120 can determine a new position point of the vehicle for each 100-m of travel and/or for more than 5-degrees of direction change made by the vehicle 102.

The GPS device 130 has a GPS receiver connected to an antenna 132. As the vehicle 102 travels, the GPS device 130 can periodically obtain GPS position information for the vehicle using GPS satellites 30. The GPS position information can include elevation, longitude, latitude, and time values, and the GPS device 130 can use various techniques known and used in the art for improving accuracy of the GPS information.

Using techniques know in the art, the controller 110 uses the GPS information to determine the vehicle position (i.e., position points of the vehicle 102) and to adjust, compensate, or correct the position points determined by the dead-reckoning device 120. As the vehicle 102 travels, the controller 110 stores the position points determined over time in the position history database 150. Due to memory limitations, however, it is likely that only a limited or fixed number of position point entries can be stored in the position history database 150. In one implementation, for example, the position history database 150 may maintain a history of only about twenty position points. As the vehicle travels, older position points must be deleted from the position history database 150 as newer position points are added so as not to exceed the storage limitation.

At some point during operation, the vehicle 102 may be instructed to transmit its current position points in the database 150 to a remote service provider 10. For example, the remote service provider 10 may provide Telematics, navigation, tracking, or other services for the vehicle 102. When instructed, the controller 110 accesses the current position points stored in the position history database 150 and transmits them to the service provider 10 using the wireless communication device 140, wireless antenna 142, and wireless network 40. Any suitable wireless technology could be used, such as for example, cellular technology. Again, it is noted that limitations associated with memory and wireless transmission may only allow for a limited number of position points of the position history to be transmitted to the remote service provider 10 at a given time. The remove service provider 10 uses the transmitted position history to provide any of a number of services, such as Telematics, navigation, and tracking.

As the position history apparatus 100 travels with the vehicle 102, it adds position points to the position history database 150. As long as the apparatus 100 can determine its position using a high accuracy source (e.g. the GPS device 130), then the position points can be deemed as highly reliable. Road conditions or gaps in wireless or satellite coverage, however, can prevent the apparatus 100 from receiving the radio signals used to determine position points of the vehicle 102. For example, the vehicle 102 may travel along a path having obstructed coverage, such as, for example, through a long tunnel. As the vehicle 102 travels, the position points can begin to collect significant errors caused by the use of a less accurate positioning system such as, for example, dead reckoning.

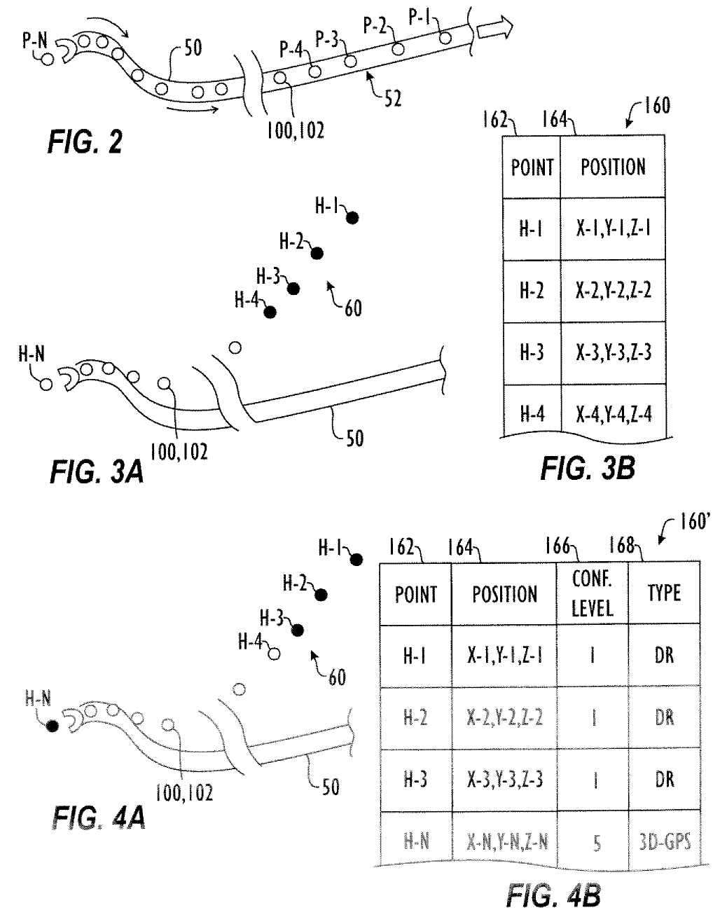

Referring to FIG. 2, the vehicle 102 is schematically illustrated traveling through a long tunnel or other such obstructed path 50. To help with the discussion below, reference is concurrently made to the element numerals of FIG. 1. The actual position of the vehicle 102 traveling through tunnel 50 is shown using a plurality of actual position points P-1, P-2, P-3, P-4, . . . , P-N, where P-1 is the most recent position. As the vehicle 102 travels through the tunnel 50, the position history apparatus 100 loses satellite coverage for the GPS device 130 and, therefore, must rely solely on the dead-reckoning techniques used by the dead-reckoning device 120 to determine the vehicle's current position.

FIGS. 3A and 3B illustrate examples of how the position history for the vehicle 102 would be determined when dead reckoning is used for an extended period of time while traveling in the tunnel 50. In FIG. 3A, an example of a plurality of vehicle positions points H-1, H-2, H-3, H-4, etc are diagrammatically illustrated. The position points H-1, H-2, H-3, H-4, etc. are determined by the position history apparatus 100 as it travels through the tunnel 50. As the vehicle 102 travels, the position history apparatus 100 loses GPS coverage and is then only able to use dead-reckoning techniques to determine the position points H-1, H-2, H-3, H-4, etc. As shown, errors have developed in the position points H-1, H-2, H-3, H-4, etc. determined by the apparatus 100 using only dead reckoning inside the tunnel 50.

If a call is made for the apparatus 100 to transmit the vehicle's position history to the remote service provider 10, the apparatus 100 transmits a finite list of the points (e.g., points H-1, H-2, H-3, and H-4), as exemplified in the position history data set 160 in the chart of FIG. 3B. The data set 160 has a first column for identifying the position points 162 and has a second column for listing the coordinates 164 of the position points. In the present example, the data set 160 is only shown storing four position points 162 (e.g. points H-1, H-2, H-3, and H-4) at one time for illustrative purposes. Due to memory limitations, it is understood that a particular implementation will typically hold a higher, fixed number (e.g., twenty) of position points in memory. Depending on the road geography around the apparatus 100, the remote service provider 10 may not be able to determine the device's actual location from the position points 162 (H-1, H-2, H-3, and H-4) transmitted by the apparatus 100. For example, the tunnel 50 may pass under an existing town or other roads, and the service provider 10 may erroneously determine that the vehicle 102 is on another of these roads because of errors in elevation, latitude, and longitude occurring in the transmitted position points 162 (H-1, H-2, H-3, and H-4).

To overcome the limitations where only dead-reckoning techniques are used for an extended period of time, the position history apparatus 100 uses a corrective technique for extending which position points will be available in the position history database 160 for eventual transmission to the service provider 10 should it be necessary. FIGS. 4A and 4B continue with examples of how the position history for the vehicle 102 may be determined and extended when dead reckoning is used for an extended period of time.

In FIG. 4A, the vehicle position points H-1, H-2, H-3, H-4, etc. determined by the position history apparatus 100 are again diagrammatically illustrated. As before, errors have developed in the position points H-1, H-2, H-3, H-4, etc. calculated by the apparatus 100 using only dead reckoning inside the tunnel 50. Again, the apparatus 100 maintains a position history data set 160′ as it travels, such as shown in FIG. 4B, and the data set 160′ includes a plurality of position points 162 for the apparatus 100. If a call is made for the apparatus 100 to transmit the vehicle's position history to the remote service provider 10, the apparatus 100 transmits the finite list of these position points 162 in the position history data set 160′ to the provider 10.

In contrast to the previously described data set 160 of FIG. 3B, however, this data set 160′ of FIG. 4B maintains at least one preferred or reliable position point 162. For example, in the context of traveling through the tunnel 50, the data set 160′ includes an earlier (i.e., older) position point H-N that represents the last known, good position point determined by the apparatus 100 at the mouth of the tunnel 50. This older position point H-N represents the last position where GPS 30 were visible to the apparatus 100. Such a position point is assumed to be highly reliable because GPS is more reliable than dead reckoning alone and because at least two sources, both dead reckoning and GPS, have been relied upon to determine the position point H-N. Accordingly, this preferred position point H-N is flagged or otherwise protected in the list of position points 162 in the continually ongoing and updated data set 160′.

As new position points being added to the data set 160′ replace existing position points 162 in the data set 160′, the protected position point 162 (e.g., H-N) is at least temporarily protected from being replaced in the data set 160′. In this way, the data set 160′ maintains at least one older, more reliable position point 162 as the vehicle 102 travels in the event the position points 162 are to be transmitted to the service provider 10. In the present scenario of the tunnel 50, this protected position point 162 (e.g., H-N) would ensure that at least one position point 162 to be transmitted to the service provider 10 occurs at or near the mouth of the tunnel 50. Ostensibly, this protected position point 162 (e.g., H-N) would have more accurate latitude, longitude, and elevation based on GPS.

The data set 160′ can also be further extended by determining a confidence level 166 for each of the stored position points 162. The confidence level 166 is determined from what type or types of techniques were used to calculate or determine the position points 162. The data set 160′ may also include an indication 168 of the type or types of techniques were used to obtain the position point 162. For example, the types of techniques to obtain position points can include dead reckoning alone (based on one or more of distance traveled, speed, direction change, etc.), two-dimensional (2-D) GPS (i.e., longitude and latitude), three-dimensional (3-D) GPS (i.e., longitude, latitude, and elevation), and a combination of these. The confidence level 166 for a particular position point 162 can be either higher or lower based on the reliability of the type of technique that was used to obtain the position point 162. In addition, the confidence level 166 for a particular position point 162 may be adjusted higher or lower based on its proximity to a more reliably obtained position point 162. For example, a first position point 162 obtained with dead reckoning only and directly following a position point obtained using GPS would have less potential for errors and would have a higher confidence level 166 than the several subsequent position points 162 obtained later with only dead-reckoning techniques.

When the position points 162 of the extended data set 160′ are transmitted to the service provider 10, the direction of the vehicle 102 can generally be determined from the unprotected position points 162 (e.g., H-1, H-2, and H-3). The protected position point 162 (e.g., H-N) can be used to correct or counter at least some of the intrinsic errors contained in the other position points 162 (e.g., H-1, H-2, and H-3) transmitted to the service provider 10. For example, the protected position point 162 (e.g. H-N) when compared to mapping information of the region could be used determine that the apparatus 100 is still situated within the tunnel 50. The service provider 10 can use the confidence level 166 and/or the types 168 of techniques used to analyze the transmitted position points 162 and position information 164.

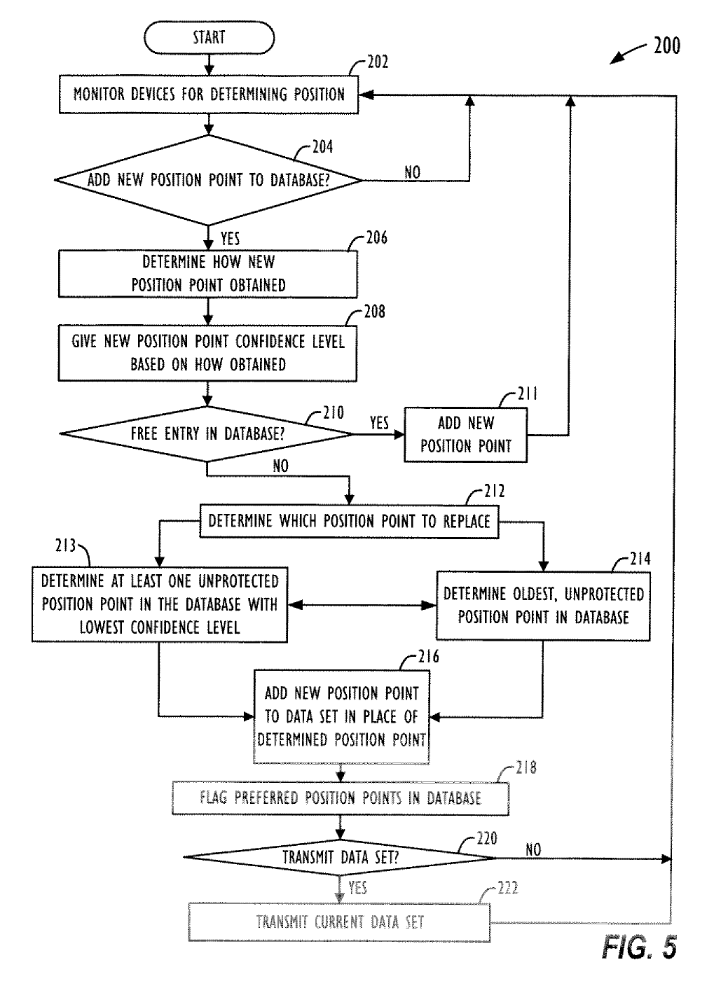

With an understanding from the above examples of how the position history apparatus 100 maintains certain preferred position points of the vehicle in the position history that can be transmitted to the service provider 10, we now turn to a flowchart in FIG. 5 that illustrates an embodiment of a process 200 for maintaining preferred vehicle position points in memory of the apparatus 100. For illustrative purpose, element numerals from FIG. 1 are concurrently provided.

In the process 200, the controller 110 of the position history apparatus 100 monitors the dead-reckoning device 120 and the GPS device 130 used to determine position of the apparatus 100 as the vehicle 102 travels (Block 202). Next, the controller 110 determines whether to add a new vehicle position point to the position history database 150 (Block 204). The controller 100 may determine whether to add a new position point based on how far the vehicle 102 has traveled or has changed direction. If a new position is not to be added, then the controller 110 returns to Block 202 to monitor the position devices 120 and 130.

If a new position point is to be added, then the controller 110 obtains the new position point using one or more of the devices 120 and 130 (Block 206). The controller 100 then gives the new position point a confidence level based on how it was obtained (Block 208). If the new position point is obtained through dead reckoning alone, for example, then the new position point is given a lower confidence level than a position point that was obtained using 3-D GPS.

Once the confidence level has been determined, the controller 110 determines whether there is a free entry in the database 150 (Block 210). For example, the vehicle 102 may have just started traveling, and the database 150 may not have reached its limit of position history entries that it can store. Alternatively, the storage limit on the number of entries for the database 150 can change during operation due to any of a number of reasons, such as unrelated information being deleted from storage. If a free entry is available, then the new position point is added to the database 150 (Block 211), and operation returns to monitoring the devices 120 and 130 for new position points as the vehicle travels (Block 202).

If a free entry is not available in the database 150 (e.g., because the storage limit has been met), then the controller 110 determines which position point in the database to replace with the new position point (Block 212). Depending on what information is compared or analyzed to make this determination, there are a number of options available to determine which of the existing position points stored in the database 150 should be replaced by the new position point. In general, older position points are preferably deleted when new position points are added as the apparatus 100 travels with the vehicle 102. However, one desire is to protect one or more position points in the database 150 no matter how old they become if less reliable position points are being added. The position points that are flagged as protected are those with higher confidence levels. Consequently, these protected position points are preferably not deleted from the database 150 as long as new, less reliable position points are obtained by the apparatus 100 as it travels.

In one option for determining which position point to replace, the confidence level of the new position point can be compared to the confidence levels of those position points already stored in the database 150. In this option, the controller 110 compares the confidence level of the new position point to the confidence levels of the existing position points in the position history database 150 before adding the new position point. Preferably, the comparison is made to the unprotected position points in the database 150. From the comparison of the confidence levels, the controller 110 determines whether the new position point has a confidence level that is greater than or equal to at least one of the currently unprotected position points in the database 150 (Block 213). If so, then the new position point can be added to the database 150 to replace the unprotected position point with the lowest confidence level (Block 216)

In another option for determining which position point to replace, the controller 110 can determine which of the unprotected position points in the database 150 is the oldest entry (Block 216). How old an entry is can be determined by the age of the entry (i.e., the amount of time from when the position point in the entry was obtained to the present). Alternatively, how old an entry is can be determined by how much distance the vehicle 102 has traveled since obtaining that position point. In addition, the position points can be given sequence numbers as they are obtained during travel so that a position point with the lowest number in the sequence would be the oldest of those in the database 150.

Even though the “oldest” position point may have been protected in past iterations, the fact that it is unprotected and is oldest of all the others makes it the least desirable position point to keep in the database 150. After the determination, the oldest, unprotected position point is deleted from the database 150 due to the storage limitations, and the new position point is added to the database 150 to replace it so that the database maintains its maximum number of entries (Block 216).

Yet another option for determining which position point to replace can involve a combination of the acts performed in Blocks 213 and 214. For example, after determining the oldest unprotected position point in the database 150, the controller 110 can compare the confidence level of the new position point to that of the oldest, unprotected position point. If the confidence level for the new position point is not found to be greater than or equal to that of the oldest, unprotected position point, then the controller 110 can determine whether the confidence level for the new position point is greater than or equal to that of any of the other unprotected position points in the database 150, and the controller 150 can replace that position point with the new position point.

Other options for determining which position point to replace are also possible. In one example, the confidence level of the new position point can be compared to the confidence levels of protected position points in the database 150 if desired. In comparing position points, the new position point can be compared within ranges of the confidence levels of the position points in the database 150. In addition, the new position point can be compared within ranges of age or distances traveled between the position points in the database 150.

After adding the new position point to the database 150, one or more of the position points in the database 150 with the highest confidence levels are then flagged as protected (Block 218). This may require a reassessment of the confidence levels of those current position points in the database 150. Thus, the position points that are protected or not protected may change after adding the new position point to the database 150. The number of position points that are flagged as protected depends on how many position points are stored in the database 150 and depends on how many position points are to be protected as preferred, reliable position points for tracking and other purposes.

Finally, the controller 110 determines whether to transmit the current position points in the database 150, for example, if the service provider 10 initiates a call to the apparatus 100 requesting the current position history of the vehicle 102 (Block 220). If requested, the position history apparatus 100 transmits the current position points in the database 150 to the provider 10 (Block 222), and the controller 110 returns to Block 202 to monitor the position determining devices 120 and 130.

The process described above as well as the other techniques disclosed herein can be implemented as program instruction stored on a programmable storage device. The program instructions can cause a programmable control device to perform the process described above as well as the other techniques disclosed herein.

The foregoing description of preferred and other embodiments is not intended to limit or restrict the scope or applicability of the inventive concepts conceived of by the Applicants. In exchange for disclosing the inventive concepts contained herein, the Applicants desire all patent rights afforded by the appended claims. Therefore, it is intended that the appended claims include all modifications and alterations to the full extent that they come within the scope of the following claims or the equivalents thereof.

What is claimed is:

1. A vehicle position history apparatus, comprising:
at least one device configured to obtain vehicle positions;
a database configured to store a plurality of the position points of the vehicle, wherein each position point has a confidence level; and
a controller operatively coupled to the at least one device and the database and configured to:
assign a confidence level to a new position point of the vehicle based on how the new position point is obtained;
determine one of the position points stored in the database to replace with the new position point;
replace the determined position point stored in the database with the new position point based on the determination; and
protect one or more the position points at least temporarily from being replaced in the database based on the confidence levels.

2. The apparatus of claim 1, wherein to protect one or more the position points at least temporarily from being replaced in the database based on the confidence levels of the position points, the controller is configured to:
determine which position points have a confidence level greater than the confidence levels of the other position points in the database; and
protect those one or more position points in the database having the greater confidence level.

3. The apparatus of claim 1, wherein to determine the one position point stored in the database and to replace the determined position point stored in the database with the new position point, the controller is configured to:
determine which of the unprotected position points stored in the database is oldest;
delete the oldest unprotected position point from the database; and
add the new position point to the database.

4. The apparatus of claim 1, wherein to determine the one position point stored in the database and to replace the determined position point stored in the database with the new position point, the controller is configured to:
determine which of the unprotected position points stored in the database is oldest;
determine whether the confidence level of the new position point is greater than or equal to the confidence level of the oldest unprotected position point stored in the database;
delete the oldest unprotected position point from the database if the confidence level of the new position point is greater than or equal to the confidence level of the oldest unprotected position point in the database; and
add the new position point to the database.

5. The apparatus of claim 4, wherein if the confidence level of the new position point is not greater than or equal to the confidence level of the oldest unprotected position point stored in the database, the controller is configured to:
determine whether the confidence level of the new position point is greater than or equal to the confidence level of at least one of the unprotected position points stored in the database; and
delete the at least one unprotected position point from the database if the confidence level of the new position point is greater than or equal to the confidence level of the at least one unprotected position point in the database.

6. The apparatus of claim 1, wherein to determine the one position point and to replace the determined position point with the new position point, the controller is configured to:
determine whether the confidence level of the new position point is greater than or equal to the confidence level of at least one of the unprotected position points stored in the database; and
delete the at least one unprotected position point from the database if the confidence level of the new position point is greater than or equal to the confidence level of the at least one unprotected position point in the database; and
add the new position point to the database.

7. The apparatus of claim 6, wherein if the confidence level of the new position point is greater than or equal to the confidence level of the at least one unprotected position point in the database, the controller is configured to:
determine which of the unprotected position points stored in the database is oldest; and
delete the oldest unprotected position point from the database.

8. The apparatus of claim 1, wherein the at least one device comprises one or more of a global positioning system device, a wireless communication device, and a dead-reckoning device.

9. The apparatus of claim 1, wherein to assign the confidence level to the new position point, the controller is configured to:
assign the new position point with a high confidence level if the new position point is obtained using a global positioning system; and
assign the new position point with a low confidence level if the new position point is obtained using dead-reckoning.

10. The apparatus of claim 1, further comprising a wireless communication device operatively coupled to the controller and configured to transmit the position points stored in the database.

11. A vehicle position history method, comprising:
obtaining position data of a vehicle;
assigning a confidence level to the position data based on how the position data is obtained;
storing the position data in a database, the database having a limited number of entries for storing the position data for the vehicle; and
protecting one or more entries of the position data stored in the database that have confidence levels greater than the confidence levels of the other entries of the position data stored in the database,
wherein if the database has no free entry in which to store the position data, then the method comprises:
determining one of the entries of the position data stored in the database to replace, and
based on the determination, replacing the position data of the determined entry with the position data not already stored in the database.

12. The method of claim 11, wherein the act of protecting one or more entries of the position data stored in the database comprises preventing replacement of the protected entries stored in the database at least temporarily.

13. The method of claim 11, wherein the act of determining comprises determining which of the unprotected entries of the position data already stored in the database is oldest, and wherein the act of replacing comprises replacing the position data of the oldest unprotected entry with the position data not already stored in the database.

14. The method of claim 11, wherein the act of determining comprises comparing the confidence level for the position data not already stored in the database with the confidence levels for the position data already stored in unprotected entries in the database.

15. The method of claim 14, wherein the act of replacing comprises replacing the position data of the oldest unprotected entry with the position data not already stored in the database if its confidence level is greater than or equal to that of the oldest unprotected entry.

16. The method of claim 14, wherein the act of replacing comprises replacing the position data of at least one unprotected entry with the position data not already stored in the database if its confidence level is greater than or equal to that of the at least one unprotected entry.

17. The method of claim 11, wherein the act of obtaining the position data of the vehicle comprises using at least one of a global positioning system, a wireless network, and dead reckoning to obtain the position data.

18. The method of claim 11, wherein the act of assigning the confidence level to the position data based on how the position data is obtained comprises:
assigning the position data with a high confidence level if obtained using a global positioning system; and
assigning the position data with a low confidence level if obtained using dead reckoning.

19. The method of claim 11, further comprising communicating the entries of the position data stored in the database from the vehicle with a wireless network.

20. A programmable storage device having program instruction stored thereon for causing a programmable control device to perform the following functions:
obtaining position data of a vehicle;
assigning a confidence level to the position data based on how the position data is obtained;
storing the position data in a database, the database having a limited number of entries for storing the position data for the vehicle; and
protecting one or more entries of the position data stored in the database that have confidence levels greater than the confidence levels of the other entries of the position data stored in the database,
wherein if the database has no free entry in which to store the position data, then the method comprises:
determining one of the entries of the position data stored in the database to replace, and
based on the determination, replacing the position data of the determined entry with the position data not already stored in the database.
